(19) United States
(12) Patent Application Publication
(10) Pub. No.: US 2002/0125142 A1
(43) Pub. Date: Sep. 12, 2002

(54) Plating bath organic additive analyzer

(76) Inventors: Zhi-Wen Sun, San Jose, CA (US); Chunman Yu, Sunnyvale, CA (US); Girish Dixit, San Jose, CA (US)

Correspondence Address: PATENT COUNSEL, APPLIED MATERIALS, INC., Legal Affairs Department, P.O. BOX 450A, Santa Clara, CA, 95052, US

(21) Appl. No.: 10/051,611

(22) Filed: Jan. 18, 2002

Related U.S. Application Data
(60) Provisional application No. 60/262,603, filed on Jan. 18, 2001.

(51) Int. Cl. C25D 21/18; B23H 3/02; C25C 3/16; C25C 3/20

(52) U.S. Cl. 205/101; 204/228.6

(57) ABSTRACT

Embodiments of the invention generally provide and apparatus and method for measuring organic additives in an ECP solution. The apparatus generally includes a high performance liquid chromatography (HPLC) column configured to receive an electrolyte fluid supply. The HPLC column operates to separate various organic additives from the electrolyte solution flowing therethrough. The remaining flow of electrolyte solution, which generally contains only a single organic additive therein, may then be passed to a CVS apparatus for analysis thereof. Inasmuch as the electrolyte flow contains only a single organic additive, the measurement accuracy is improved substantially. Further, a plurality of HPLC columns may be implemented to separate various organics out of the flowing electrolyte solution, and therefore, measure the flowing electrolyte solution for a plurality of organic additive concentrations therein.

### CROSS-REFERENCE TO RELATED APPLICATIONS

This application claims benefit of United States provisional patent application serial No. 60/262,603, filed Jan. 18, 2001, which is incorporated by reference herein.

### BACKGROUND OF THE INVENTION

1. Field of the Invention

Embodiments of the invention generally relate to analysis of electrochemical plating solutions, and more particularly, to the analysis of additives in electroplating solutions.

2. Description of the Related Art

Metallization of sub-quarter micron sized features is a foundational technology for present and future generations of integrated circuit manufacturing processes. More particularly, in devices such as ultra large scale integration-type devices, i.e., devices having integrated circuits with more than a million logic gates, the multilevel interconnects that lie at the heart of these devices are generally formed by filling high aspect ratio interconnect features with a conductive material, such as copper or aluminum, for example. Conventionally, deposition techniques such as chemical vapor deposition (CVD) and physical vapor deposition (PVD) have been used to fill interconnect features. However, as interconnect sizes decrease and aspect ratios increase, void-free efficient interconnect feature fill via conventional deposition techniques becomes increasingly difficult. As a result thereof, plating techniques, such as electrochemical plating (ECP) and electroless plating, for example, have emerged as viable processes for filling sub-quarter micron sized high aspect ratio interconnect features in integrated circuit manufacturing processes.

In an ECP process, for example, sub-quarter micron sized high aspect ratio features formed into the surface of a substrate may be efficiently filled with a conductive material, such as copper, for example. ECP plating processes are generally two stage processes, wherein a seed layer is first formed over the surface features of the substrate, and then the surface features of the substrate are exposed to an electrolyte solution, while an electrical bias is simultaneously applied between the substrate and an anode positioned within the electrolyte solution. The electrolyte solution is generally rich in ions to be plated onto the surface of the substrate, and therefore, the application of the electrical bias causes these ions to be urged out of the electrolyte solution and to be plated onto the seed layer. Furthermore, the electrolyte solution generally contains organic additives, such as, for example, levelers, suppressors, accelerators, brighteners, etc., that are configured to increase the efficiency and controllability of the plating process. These additives are generally maintained within narrow tolerances, so that the repeatability in controllability of the plating operation may be maintained and repeated.

Monitoring and/or determining the composition of an electrolyte solution during an ECP process is problematic, as the depletion of certain additives is not necessarily constant over a period of time, nor is it always possible to correlate composition with the electrolyte solution use. As such, it is difficult to determine the amount of additives in an electrolyte solution with any degree of accuracy over time, as the level of additives may either decrease or increase as the plating that is used, and therefore, eventually exceed or fall below the tolerance range for optimal and controllable plating. Conventional ECP systems generally utilize a cyclic voltammetric stripping (CVS) process to determine the organic additive concentrations in an ECP solution. In a CVS process, the potential of a working electrode is swept through a voltammetric cycle that includes both a metal plating range and a metal stripping range. The potential of the working electrode is swept through at least two baths of non-plating quality, and an additional bath where the quality or concentration of organic additives therein is unknown. In this process, an integrated or peak current used during the metal stripping range may be correlated with the quality of the non-plating bath. As such, the integrated or peak current may be compared to the correlation of the non-plating bath, and the quality of the unknown plating bath determined therefrom. The amount of metal deposited during the metal plating cycle and then redissolved into the plating bath during the metal stripping cycle generally correlates to the concentration of particular organics, generally brighteners or accelerators, in the electrolyte solution. CVS methods generally observe the current density of the copper ions reduced on an electrode at a predetermined potential, inasmuch as accelerators or brighteners increase the current density, the quantity may be determined from the observation.

However, one challenge associated with utilizing CVS for determining the quantity of organics in an ECP solution is that contaminants resulting from the breakdown of the organics themselves buildup on the CVS electrodes and reduce the sensitivity of the CVS measurement process. As such, there is a need for an apparatus and method for measuring organics in an ECP solution, wherein the apparatus and method is not susceptible to the inaccuracies of conventional CVS measurement systems.

### SUMMARY OF THE INVENTION

Embodiments of the invention generally provide an apparatus and method for measuring organic additives in an ECP solution. The apparatus generally includes a high performance liquid chromatography (HPLC) column configured to receive an electrolyte fluid supply. The HPLC column operates to separate various organic additives from the electrolyte solution flowing therethrough. The remaining flow of electrolyte solution, which generally contains only a single organic additive therein, may then be passed to a CVS apparatus for analysis thereof. Inasmuch as the electrolyte flow contains only a single organic additive, the measurement accuracy is improved substantially. Further, a plurality of HPLC columns may be implemented to separate various organics out of the flowing electrolyte solution, and therefore, measure the flowing electrolyte solution for a plurality of organic additive concentrations therein.

Embodiments of the invention further provide an electrochemical plating system, wherein the system includes a plating cell configured to receive a substrate therein and plate a metal thereon and an electrolyte solution tank in fluid communication with the plating cell via a fluid supply conduit, the electrolyte solution tank and fluid supply conduit being configured to cooperatively supply electrolyte to the plating cell. The plating system further includes a chemical cabinet in fluid communication with the electrolyte solution tank, and an electrolyte measurement device in fluid communication with the fluid supply conduit. The electrolyte measurement device generally includes an eluent delivery stage, a separation stage in fluid communication with the eluent delivery stage, and a detection stage in fluid communication with the separation stage. The plating system further includes a system controller in electrical communication with the electrolyte measurement device, the chemical cabinet, and the plating cell, the system controller being configured to provide control signals to the electrochemical plating system.

Embodiments of the invention further provide an apparatus for measuring a concentration of organic molecules in an electrolyte solution, wherein the apparatus includes a separation device, at least one organic molecule measurement device in fluid communication with at least one high-pressure liquid chromatography column, and a controller in electrical communication with the separation device and the at least one organic measurement device, the controller being configured to receive signals therefrom and supply controlling signals thereto. Further, the separation device generally includes an eluent fluid source, an electrolyte sample injection nozzle in fluid communication with an eluent stream, and at least one high-pressure liquid chromatography column in fluid communication with the eluent stream.

Embodiments of the invention further provide a method for maintaining a target organic additive concentration in an electroplating solution supplied to an electroplating cell. The method generally includes determining a real time organic additive concentration for the electroplating solution supplied to the electroplating cell, and adding fresh organic additive to the electroplating solution to adjust the concentration of the organic additive to the target organic additive concentration in accordance with the determined real time organic concentration. The determining step may generally include separating organics other than an organic additive to be measured from the electrolyte solution, and measuring the concentration of the organic additive to be measured in the electrolyte solution after the separating step.

Embodiments of the invention further provide a method for maintaining a target organic concentration in an electrochemical plating system. The method generally includes acquiring a portion of an electrolyte solution, separating at least one organic additive from the electrolyte solution, and measuring the electrolyte solution having the at least one organic additive separated therefrom for a concentration of a particular organic additive. Further, the method includes replenishing the particular organic additive in the electrolyte solution up to the target organic concentration in accordance with the measuring step.

### BRIEF DESCRIPTION OF THE DRAWINGS

So that the manner in which the above recited features of the present invention are obtained may be understood in detail, a more particular description of the invention, briefly summarized above, may be had by reference to the embodiments thereof, which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary embodiment of a plating system of the invention.

FIG. 2 illustrates a detailed schematic view of an exemplary electrolyte analysis stage that may be implemented in the plating system of the invention.

FIG. 3 illustrates another embodiment of an exemplary electrolyte analysis stage that may be implemented in the plating system of the invention.

FIG. 4 illustrates an exemplary CVS apparatus that may be implemented in the plating system of the invention.

FIG. 5 illustrates an alternative embodiment of an exemplary electrolyte analysis stage that may be implemented in the plating system of the invention.

### DETAILED DESCRIPTION OF THE PREFERRED EMBODIMENT

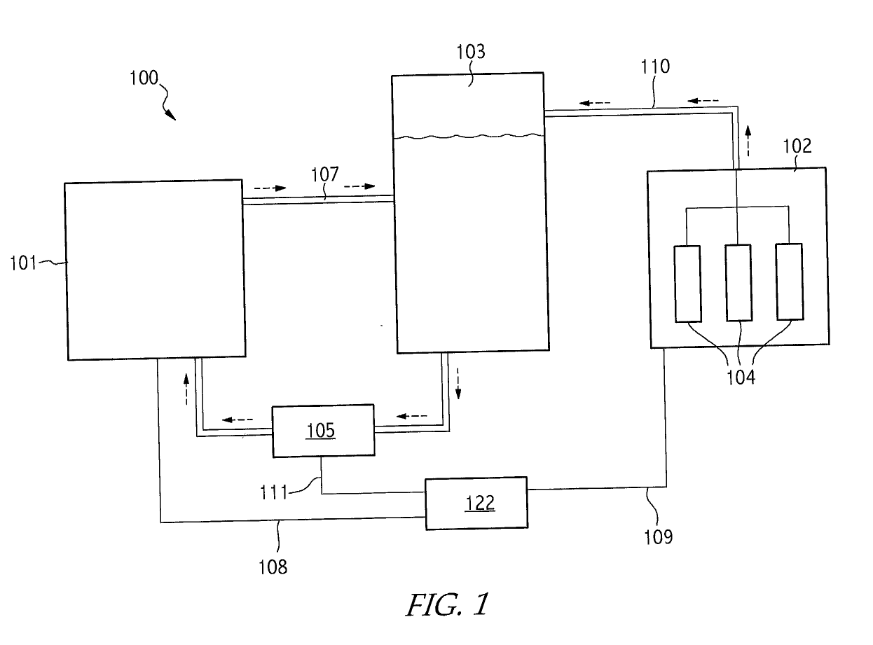

FIG. 1 illustrates an exemplary plating system 100 of the invention. Plating system 100 generally includes a plating cell 101, which may be, for example, an ECP plating cell configured to electrochemically plate copper onto a semiconductor substrate. Plating cell 101 may be selectively in fluid communication with an electrolyte tank 103 configured to maintain a large volume of electrolyte plating solution, approximately 200 liters, for example. Electrolyte tank 103 may be configured to supply an electrolyte plating solution stored therein to plating cell 101 via an electrolyte supply conduit 106. Supply conduit 106 may be in fluid communication with an electrolyte analysis device 105 configured to sample a portion of the electrolyte flowing therethrough to determine the quantity of various substances in the sampled portion of the electrolyte solution. Plating system 100 may further include a chemical cabinet 102 having one or more chemical storage units 104 positioned therein or in fluid communication therewith. Chemical cabinet 102, and in particular, chemical storage units 104, may be selectively in fluid communication with electrolyte tank 103 via chemical supply conduit 110.

Additionally, plating system 100 may include a system controller 122, which may be a microprocessor-based controller, for example, configured to control the operation of the respective components of plating system 100. System controller 122 may be in electrical communication with the components of plating cell 101 via electrical conduit 108, with the components of electrolyte analysis device 105 via electrical conduit 111, and with the components of chemical cabinet 102 via electrical conduit 109. As such, system controller may receive inputs from the various components of plating system 100 and generate control signals that may be transmitted to the respective components of system 100 for controlling the operation thereof. For example, system controller may be configured to control parameters such as the flow rate of electrolyte into plating cell 101, the timing and quantity of chemicals added to the electrolyte plating solution by chemical cabinet 102, and the operational characteristics of plating cell 101.

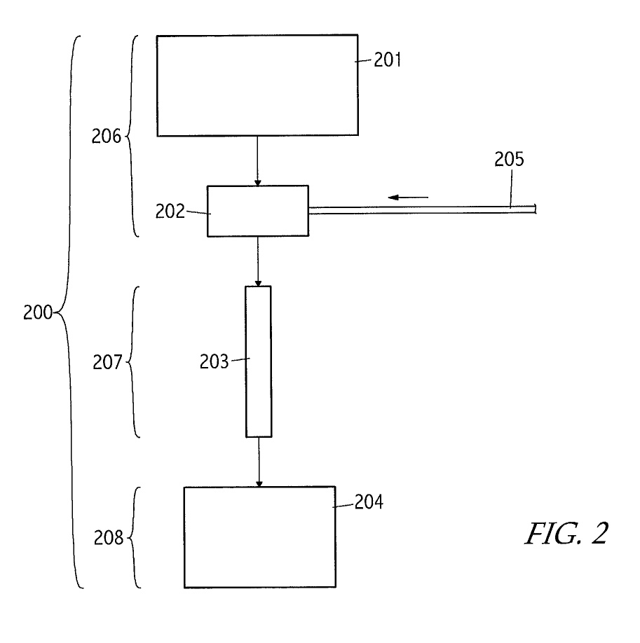

FIG. 2 illustrates a more detailed view of an exemplary electrolyte analysis device 105 of the invention. The exemplary electrolyte analysis device 105 generally includes an eluent delivery stage 206, a separation stage 207, and a detection stage 208. The eluent delivery stage generally includes an eluent source (not shown), which may be a fluid tank or reservoir, in fluid communication with a gradient pump 201. Gradient pump 201 generally operates to receive an eluent supply from the eluent source, pressurize an eluent flow, and pass the pressurized eluent flow to an injection device 202. Injection device 202 receives the pressurized eluent flow and injects a portion of the electrolyte to be measured into the pressurized eluent flow via a small aperture, such as a nozzle or hypodermic needle type device, for example. Regardless of the particular injection device, the volume of the electrolyte sample injected into the eluent stream is generally small compared to the volume of the eluent flow, and further, the volume of the injected sample is generally accurately measured. The portion of the electrolyte to be measured is generally received via conduit 205, which may be in fluid communication with the electrolyte supply line 106 illustrated in FIG. 1. The eluent flow having the portion of electrolyte to be measured therein may then be passed from the eluent delivery stage 206 to the separation stage 207, which may generally include an HPLC column 203. HPLC column 203 is generally configured to separate specific organic additives and/or contaminants from the high-pressure eluent flow. However, HPLC column 203 is generally selective to specific molecules, and therefore, HPLC column 203 may be configured to pass a specific organic molecule, such as an organic molecule to be measured in the electroplating solution, for example, therethrough without being separated from the eluent flow. More particularly, the eluent flow carries the electrolyte sample over the stationary phase, where the differences in the affinity between the components of the electrolyte and the stationary phase cause the components to separate or be resolved as the eluent carries the electrolyte through column 203. Thus, the affinity difference may be configured to separate levelers and accelerators from the eluent flow, while allowing brighteners, for example, to independently remain in the eluent flow for subsequent measurement.

The output of separation stage 207 is generally in fluid communication with detection stage 208, which may include a CVS analysis device configured to measure the presence of a specific organic molecule not separated from the high-pressure eluent flow in column 203. Therefore, the CVS analysis device 203 may accurately measure the presence and/or concentration of the specific organic molecule remaining in the high-pressure eluent flow, as the chemical interference resulting from the molecules conventionally unseparated from the measured sample are not delivered to the measuring device of the present invention, and therefore, these molecules do not cause sample measurement interference.

The separation stage 207, which is generally described above as an HPLC column, may be any device or method generally configured to separate organic compounds or molecules from an electrolyte plating solution, and therefore, is not limited to HPLC-type columns. However, inasmuch chromatography techniques, such as HPLC columns, for example, have been found to be viable separation devices in view of the cost and separation efficiency characteristics provided, they are generally viable devices for use in separating organics from electroplating solutions. Generally, however, chromatography applies to a wide variety of separation techniques, of which all are based upon the partitioning of a sample between a moving phase, which is generally a gas or liquid, and a solid phase, which may be either a liquid or a solid. Although each chromatography method or technique provides specific advantages and disadvantages, each individual technique or method may be implemented into the separation device 203 of system 100.

One type of chromatography that may be implemented into system 100, for example, is partition chromatography, which generally refers to the partitioning of a solute between two immisible liquid phases, wherein one of the phases is stationary (polar) and the other is mobile (nonpolar), such as the HPLC column discussed above. Another type of chromatography that may be used is reverse phase chromatography, which is generally a variance of partition chromatography, wherein a chemically bonded phase is hydrophobic (nonpolar) and a starting mobile phase is more polar than the stationary bonded phase. Yet another type of chromatography that may be used is ion-pair chromatography, which is generally used in conjunction with a reverse phase column and solvent system where some or all of the sample components are ionized or ionizable, which allows them to interact with an ion-pair reagent. In this type of chromatography, the retention and separation selectivity of the device is primarily driven by the characteristics of the mobile phase. Another type of separation that may be used is hydrophobic interaction chromatography (HIC), which uses a chemically bonded hydrophobic stationary phase and a mobile phase having a stronger polarity than the stationary phase. In another type of chromatography that may be used, normal phase chromatography, the stationary phase is polar and hydrophilic, and the starting mobile phase is more non-polar than the stationary phase. Sample retention is generally controlled by the adsorption to the stationary phase, and as such, sample molecules must displace elute or solvent molecules from the stationary phase in order for retention to occur. Other types of chromatography that may be implemented into the separation device 203 include ion-exchange chromatography and size exclusion chromatography, both of which are known in the art, along with other separation techniques known in the art to be viable for separating organic molecules from a plating electrolyte.

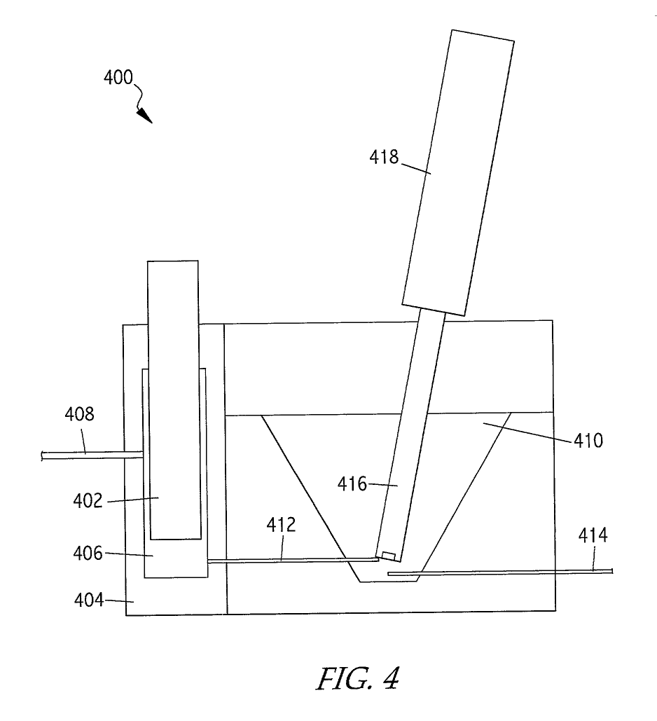

The detection device 204, which may generally be a CVS apparatus 400, as illustrated in FIG. 4, generally includes a reference electrode 402 disposed in a reference chamber 404. The reference electrode 402 is continuously immersed in base plating solution 406 that generally contains no organic additives, or alternatively, known concentrations of additives that are not being measured by the apparatus 400. The base solution 406 is injected into reference chamber 404 through a fluid flow inlet 408, and subsequently flows into measuring chamber 410 via capillary tube 412 interconnecting the two chambers. Additional solutions containing additives are introduced into the measuring chamber 410 and are mixed with the base plating solution introduced therein via capillary tube 412. A plating current source electrode 414 is electrically and operatively coupled to an inert rotating disc electrode 416 through a reversible and controllable current source (not shown). The inert rotating disc electrode 416 is preferably mechanically and electrically coupled to a rotational driver 418 configured to impart rotational motion to the rotating disc electrode 416.

In operation, the electrical potential of the inert rotating disc electrode 416 is cycled at a generally constant rate in a plating solution within the measuring chamber 410 so that a small amount of metal is deposited on the electrode surface and then stripped off by anodic dissolution. Inasmuch as the sweep rate is generally constant, the area under the stripping peak plot is proportional to the average deposition rate, which in turn reflects the additive concentration in the plating solution. When the electrode 416 rotation is stopped, the additive, which is in relatively small concentration, becomes depleted at the electrode surface so that the stripping peak area approaches that which would be obtained if no additive were present. Thus, the ratio of the stripping peak area with rotation to that for the reference electrode 402 yields a relative rate parameter that is a sensitive measure of the additive concentration in the electroplating solution.

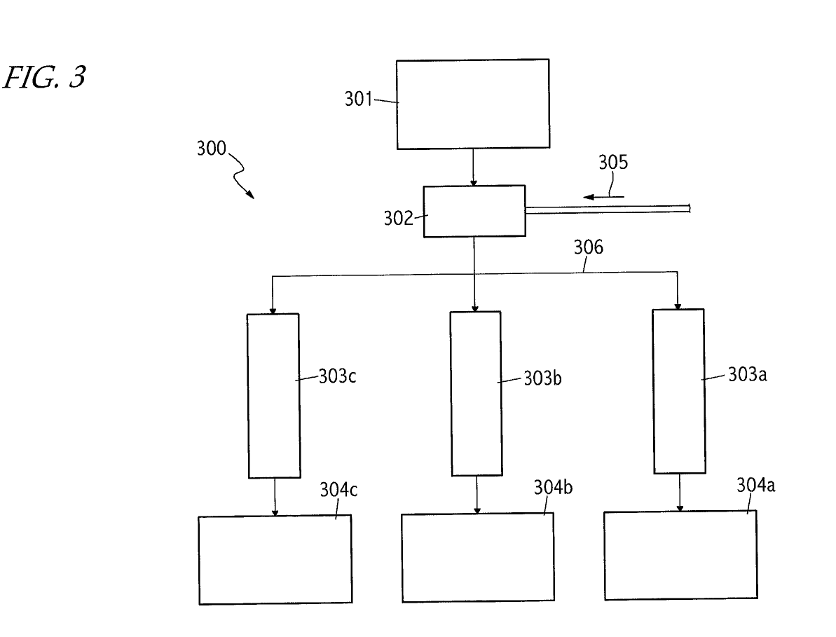

FIG. 3 illustrates another embodiment of an electrolyte analysis device of the invention. The exemplary electrolyte analysis device 300 generally includes a pump 301 in fluid communication with a solvent source (not shown). Pump 301 generates a high-pressure solvent stream that is passed to an injection device 302, which operates to inject an accurately measured small volume of electrolyte solution received from conduit 305 into the high-pressure solvent stream. The solvent stream having the electrolyte sample therein is then delivered to a manifold 306, which operates to deliver a portion of the high-pressure solvent stream having the electrolyte to be measured therein to a plurality of individual HPLC columns 303a, 303b, 303c. The individual columns separate the high-pressure solvent stream and deliver an output to a corresponding measurement device 304a, 304b, 304c.

An advantage provided by analysis device 300, is that several individual molecules may be separated from the high-pressure solvent stream by the plurality of HPLC columns 303. As such, for example, HPLC column 303a may be configured to separate all organic additive molecules from the solvent stream, less brightener molecules. In this configuration, measurement device 304a, which may be a CVS analysis device, may be configured to measure only the concentration or presence of brightener molecules. Inasmuch as the remaining organic additive molecules have been separated from the solvent stream by the HPLC column 303a, the CVS measurement accuracy is substantially improved, as the interference generated in conventional CVS measurements by the other organic additive molecules is eliminated in this configuration. Similarly, the remaining columns 303 of the plurality of columns in this embodiment may be configured to separate the solvent stream for other organic additive molecules to be measured, while each of the corresponding measurement devices 304 may be configured to measure the presence and/or concentration of the particular organic additive molecule of choice.

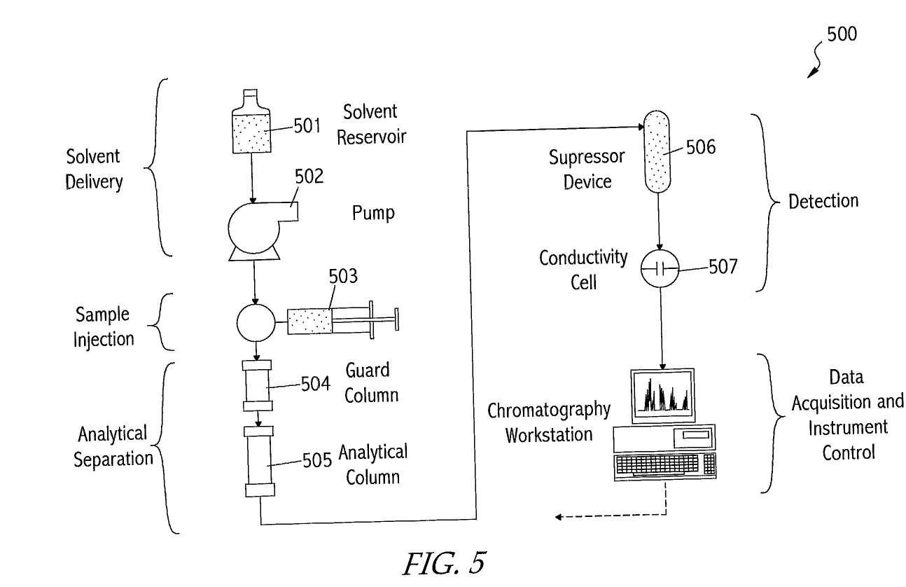

FIG. 5 illustrates an alternative embodiment of a measuring device of the invention. Measuring device 500, which may be an ion chromatograph system, generally includes a solvent reservoir 501, a high-pressure pump 502, and a sample injection device 503. The pump 502 operates to pump solvent from the reservoir 501 through the sample injection device 503, where a measured volume of an electrolyte solution to be measured may be injected into the solvent stream. Measuring device 500 may also include an analytical separation assembly, which may include a guard column 504 and an analytical separation column 505. Guard column 504 generally receives the solvent stream having the electrolyte sample therein and conducts a first stage separation operation on the solvent flow. Once the preliminary separation is completed, the output of the guard column 504 is communicated to the analytical column 505, where the remaining molecules in the solvent solution may be separated therefrom, as desired. The output of the analytical column 505 is in fluid communication with a suppressor device 506, which then passes the solvent flow to a conductivity cell for measurement.

In operation, embodiments of the invention generally provide an apparatus and method for maintaining a target organic concentration in a plating solution during a plating process. In particular, referring to the embodiment illustrated in FIG. 1, system controller 122 may be configured to receive an electrolyte measurement input from electrolyte measurement device 105. Thereafter, controller may provide a control signal to chemical cabinet 102, wherein the control signal causes chemical cabinet 102 to dispense a calculated volume of an organic additive into the plating solution tank 103. In this configuration, system controller 122 may be used to maintain a target concentration of a plurality of organic additives in a plating bath positioned in tank 103.

More particularly, controller 122 may receive a measurement signal from a electrolyte measurement device 105, wherein the measurement signal corresponds to a measured quantity of an organic additive present in a sample of the plating solution contained in tank 103. For example, measurement device 105 may receive a sample stream of electrolyte from supply conduit 106 via a slipstream configuration. The sample stream of electrolyte obtained from fluid supply conduit 106 may be dispensed into a high-pressure solvent stream generated by gradient pump, such as the gradient pump 201 illustrated in FIG. 2. The high-pressure solvent stream containing the sample of the electrolyte solution may be passed through a separation device 203, wherein the separation device 203 is configured to remove all organic additives from the plating solution, less a particular organic additive to be measured. The separated solution may then be passed to measurement device 204, which may be a CVS apparatus, for example, where the measurement device 204 is configured to determine the presence and/or concentration of the particular organic additive remaining in the solvent stream.

Once the presence and/or concentration of the particular organic additive is determined by the measurement device 204, a signal corresponding to the presence and/or concentration of the particular organic additive may be sent to controller 122 by measurement device 204. Controller 122 may then compare the measured concentration of the particular organic additive to a target concentration of the particular organic additive, wherein the target concentration may be predetermined and/or calculated through an algorithm. Controller 122 may then generate an output signal corresponding to the comparison, where the output signal is to be transmitted to the chemical cabinet. The output signal is generally configured to control the operation of chemical cabinet 102, and more particularly, to open various styles in the chemical cabinet 102 to dispense a calculated quantity of an organic additive stored in chemical cabinet 102 into the electrolyte solution tank 103. The calculated quantity of the particular organic additive is generally determined by controller 102 to be the quantity of the particular organic additive required to be added to electrolyte solution tank 103 in order to bring the concentration of the particular organic additive within electrolyte solution tank 103 to a desired or predetermined concentration level. Therefore, controller 122 essentially operates to receive a measurement signal corresponding to a concentration of a particular organic additive in electrolyte solution, and then generates a control signal configured to cause a chemical cabinet to dispense an appropriate quantity of the measured additive into the solution tank. The measured quantity, which may be calculated by controller 122, generally corresponds to the quantity or volume required to bring the concentration of the measured additive in the electrolyte solution to a target or predetermined level.

With regard to the operation of the embodiment illustrated in FIG. 3, an eluent stream may be generated and pumped by pump 301 through nozzle device 302, where a sample electrolyte stream to be measured may be inserted therein. The output of the nozzle device 302 may be in fluid communication with a manifold 306, wherein manifold 306 operates to receive a single fluid stream and divide the fluid stream into a plurality of equal volume outputs. Each of the outputs of manifold 306 are then communicated to individual HPLC columns 303a, 303b, 303c for appropriate separation. For example, columns 303 may be configured to separate all organic molecules out of the fluid stream, less brightener molecules. Therefore, measuring device 304a may be configured to determine the concentration of brighteners in the fluid stream delivered thereto from HPLC column 303a. Similarly, HPLC column 303b may be configured to separate all our Gannett molecules out of the fluid stream, less the accelerator molecules. Thus, CVS measuring device 304b may be configured to determine the concentration of the accelerator molecules in the fluid solution delivered thereto. As such, through the use of a plurality of HPLC columns in conjunction with a plurality of CVS analyzers, embodiments of the invention generally provide an apparatus and method configured to simultaneously measure electrolyte solution for the concentration of various organic additives, wherein the measurement is not subject to interference elements introduced by the presence of non-measured organic additives.

In another embodiment of the invention, a total organic carbon (TOC) analysis may be conducted through the use of an electrochemical detector in conjunction with an HPLC unit, such as the HPLC column discussed above. The present invention generally utilizes the electrochemical detector to monitor the levels of TOC in the plating solution by pumping a dedicated sample line of the plating solution into the electrical chemical detector without going through the HPLC separation stage. Subsequently, the oxidation current under very positive potential may be used to evaluate the TOC level. The interference of oxidizable inorganic components, such as chlorine, for example, may be subtracted from the total oxidation current through knowing the chlorine concentration (with inorganic titration, for example) and its oxidation current under the applied potential.

While the foregoing is directed to embodiments of the invention, other and further embodiments of the invention may be devised without departing from the basic scope thereof, which is to be determined by the claims that follow.

1. An electrochemical plating system, comprising:
a plating cell configured to receive a substrate therein and plate a metal thereon;
an electrolyte solution tank in fluid communication with the plating cell via a fluid supply conduit, the electrolyte solution tank and fluid supply conduit being configured to cooperatively supply electrolyte to the plating cell;
a chemical cabinet in fluid communication with the electrolyte solution tank;
an electrolyte measurement device in fluid communication with the fluid supply conduit, the electrolyte measurement device comprising:
an eluent delivery stage;
a separation stage in fluid communication with the eluent delivery stage; and
a detection stage in fluid communication with the separation stage; and
a system controller in electrical communication with the electrolyte measurement device, the chemical cabinet, and the plating cell, the system controller being configured to provide control signals to the electrochemical plating system.

2. The electrochemical plating system of claim 1, wherein the chemical cabinet comprises at least one organic plating additive storage unit that is selectively in fluid communication with the electrolyte solution tank and is configured to dispense an organic plating additive therein.

3. The electrochemical plating system of claim 1, wherein the eluent delivery stage comprises:
an eluent supply;
a gradient pump in fluid communication with the eluent supply; and
a sample injection device in fluid communication with the gradient pump.

4. The electrochemical plating system of claim 3, wherein the sample injection device is configured to receive an electrolyte sample and inject a small volume of the received electrolyte sample into a high-pressure eluent stream generated by the gradient pump.

5. The electrochemical plating system of claim 1, wherein the separation stage comprises at least one high-pressure liquid chromatography column.

6. The electrochemical plating system of claim 5, wherein each of the at least one high-pressure liquid chromatography columns is configured to separate an individual plating solution organic additive from an eluent flow passing therethrough.

7. The electrochemical plating system of claim 1, wherein the detection stage comprises at least one cyclic voltammetric stripping apparatus configured to determine a concentration of an organic additive in the electrolyte.

8. The electrochemical plating system of claim 1, wherein the system controller comprises a microprocessor-type controller configured to receive inputs from plating system components and generate outputs configured to control the operation of the electrochemical plating system.

9. The electrochemical plating system of claim 8, wherein the inputs comprise organic additive measurements from the detection stage and the outputs comprise chemical cabinet valve control signals.

10. The electrochemical plating system of claim 9, wherein the chemical cabinet valve control signals are configured to selectively open at least one valve in the chemical cabinet to dispense an organic plating additive into the electrolyte solution tank.

11. The electrochemical plating system of claim 1, wherein the electrolyte measuring device is positioned in a slipstream conduit of the fluid supply conduit.

12. An apparatus for measuring a concentration of organic molecules in an electrolyte solution, comprising:
a separation device, comprising:
an eluent fluid source;
an electrolyte sample injection nozzle in fluid communication with an eluent stream; and
at least one high-pressure liquid chromatography column in fluid communication with the eluent stream;
at least one organic molecule measurement device in fluid communication with the at least one high-pressure liquid chromatography column; and
a controller in electrical communication with the separation device and the at least one organic measurement device, the controller being configured to receive signals therefrom and supply controlling signals thereto.

13. The apparatus of claim 12, further comprising a chemical cabinet in fluid communication with an electrolyte supply tank, the chemical cabinet being configured to selectively dispense fresh organics into the electrolyte supply tank.

14. The apparatus of claim 12, wherein the chemical cabinet is in electrical communication with the controller and receives controlling signals therefrom configured to regulate dispensing of organics into the electrolyte supply tank.

15. The apparatus of claim 12, wherein the at least one organic molecule measurement device comprises a cyclic voltammetric stripping device.

16. The apparatus of claim 12, wherein the eluent source comprises a solvent storage tank and a gradient pump in fluid communication with the solvent storage tank, the gradient pump being configured to generate the eluent stream.

17. The apparatus of claim 12, wherein the controller comprises a microprocessor-type controller configured to receive input signals from the at least one measurement device corresponding to an organic additive concentration and generate an output signal to be transmitted to a chemical cabinet, the output signal being configured to control the chemical cabinet to dispense an amount of an organic additive into the electrolyte solution.

18. The apparatus of claim 17, wherein the controller is configured to receive the input signals and generate the output signal during a processing time period.

19. The apparatus of claim 12, wherein the at least one high-pressure liquid chromatography column comprises an independent high-pressure liquid chromatography column for each organic molecule to be measured.

20. A method for maintaining a target organic additive concentration in an electroplating solution supplied to an electroplating cell, comprising:
determining a real time organic additive concentration for the electroplating solution supplied to the electroplating cell, wherein the determining step comprises:
separating organics other than an organic additive to be measured from the electrolyte solution; and
measuring the concentration of the organic additive to be measured in the electrolyte solution after the separating step; and

21. The method of claim 20, further comprising adding fresh organic additive to the electroplating solution to adjust the concentration of the organic additive to the target organic additive concentration.

22. The method of claim 20, wherein separating organics comprises flowing a portion of the electrolyte solution through a liquid chromatography assembly configured to separate specific organics from the electrolyte solution.

23. The method of claim 20, wherein separating organics comprises flowing a portion of the electrolyte solution through at least one high-pressure liquid chromatography column.

24. The method of claim 20, wherein separating organics comprises:
dispensing a portion of the electrolyte solution into a high-pressure solvent stream; and
flowing the high-pressure solvent stream having the portion of electrolyte solution dispensed therein through at least one high-pressure liquid chromatography column.

25. The method of claim 20, wherein measuring the concentration of the organic additive comprises using at least one cyclic voltammetric stripping assembly.

26. The method of claim 21, wherein adding fresh organic additive comprises using an electronically controlled chemical cabinet in fluid communication with an electrolyte supply tank, the electronically controlled chemical cabinet being configured to dispense a calculated portion of the fresh organic additive into the electrolyte supply tank.

27. The method of claim 26, wherein electronically controlled chemical cabinet is in electrical communication with a system controller, the system controller being configured to receive an organic concentration measurement from a measurement device, determine an amount of fresh organic additive to be added to the electrolyte supply tank, and control a dispensing process of an amount of fresh organic additive into the electrolyte supply tank.

28. The method of claim 27, wherein the dispensing process is configured to provide a target concentration of the organic additive in the electrolyte supply tank.

29. The method of claim 21, wherein adding fresh organic additive further comprises adding one or more organic additives to the electroplating solution to achieve a predetermined target concentration of each of the one or more organic additives present in the plating solution.

30. A method for maintaining a target organic concentration in an electrochemical plating system, comprising:
acquiring a portion of an electrolyte solution;
separating at least one organic additive from the electrolyte solution;
measuring the electrolyte solution having the at least one organic additive separated therefrom for a concentration of a particular organic additive; and
replenishing the particular organic additive in the electrolyte solution up to the target organic concentration in accordance with the measuring step.

31. The method of claim 30, wherein acquiring a portion of an electrolyte solution comprises removing a portion of an electrolyte solution flowing to the electrochemical plating cell via a slipstream assembly.

32. The method of claim 30, wherein separating at least one organic additive comprises flowing a small volume of the acquired portion of electrolyte solution through at least one separator.

33. The method of claim 32, wherein flowing a small volume comprises passing a measured volume of the electrolyte solution through a nozzle assembly to dispense a measured volume of the electrolyte solution into a slowing solvent stream.

34. The method of claim 32, wherein the at least one separator comprises at least one high-pressure liquid chromatography column.

35. The method of claim 30, wherein separating at least one organic additive comprises:
generating a high-pressure solvent stream;
dispensing a measured small volume portion of the electrolyte solution into the high-pressure solvent stream; and
passing the high-pressure solvent stream having the measured small volume of the electrolyte solution therein through at least one liquid chromatography separator device.

36. The method of claim 35, wherein the at least one liquid chromatography separator device comprises at least one high-pressure liquid chromatography column.

37. The method of claim 36, wherein the at least one high-pressure liquid chromatography column is configured to have an affinity for a selected first group of organic molecules, while allowing a second group of organic molecules to pass therethrough.

38. The method of claim 30, wherein measuring the electrolyte solution comprises delivering the separated electrolyte solution to at least one cyclic voltammetric stripping apparatus.

39. The method of claim 30, further comprising controlling the operation of the measuring and replenishing steps with a system controller.

40. The method of claim 39, further comprising:
receiving an organic concentration measurement signal in the system controller;
determining an amount of organic additive to be added to the electrolyte solution to achieve a target concentration; and
sending a control signal to a chemical cabinet, wherein the control signal is configured to cause the chemical cabinet to dispense a calculated amount of the organic additive into the electrolyte solution to achieve the target concentration.

41. The method of claim 39, wherein the system controller is a microprocessor-based control system configured to receive inputs and generate control signal outputs in accordance with a system control program executed thereon.
